(19) United States
(12) Patent Application Publication
(10) Pub. No.: US 2024/0062931 A1
(43) Pub. Date: Feb. 22, 2024

(54) COMPOSITION

(71) Applicant: BOREALIS AG, Vienna (AT)

(72) Inventors: Per-Ola HAGSTRAND, Stenungsund (SE); Thomas GKOURMPIS, Stenungsund (SE); Christian MÜLLER, Göteborg (SE); Yingwei OUYANG, Göteborg (SE); Amir Masoud POURRAHIMI, Göteborg (SE)

(21) Appl. No.: 18/271,319

(22) PCT Filed: Jan. 10, 2022
(86) PCT No.: PCT/EP2022/050331

§ 371 Date: Jul. 7, 2023

(30) Foreign Application Priority Data
Jan. 8, 2021 (EP) 21150777.7

(51) Int. Cl. H01B 3/44; C08L 23/06

(52) U.S. Cl. CPC H01B 3/441; C08L 23/06; H01B 9/00

(57) ABSTRACT

A cable, preferably a power cable, comprising one or more conductors surrounded by at least one layer, wherein said layer comprises (i) 15 to 84.5 wt % low density polyethylene (LDPE); (ii) a polypropylene; and (iii) a styrene block copolymer; wherein the weight percentages are based on the layer as a whole.

This invention relates to polymer compositions which comprise a low density polyethylene (LDPE), a polypropylene and a styrene block copolymer. In particular, the compositions of the invention offer exceptionally low DC conductivity and hence these compositions are suitable for use in the insulation layer of a cable. The invention also concerns cables in which at least one layer thereof comprises a low density polyethylene (LDPE) and a polypropylene. Ideally, compositions and cables of the invention are free of peroxides. The invention also relates to processes for preparing such cables.

### BACKGROUND

Polyolefins produced in a high pressure (HP) process are widely used in demanding polymer applications where the polymers must meet high mechanical and/or electrical requirements. For instance in power cable applications, particularly in medium voltage (MV) and especially in high voltage (HV) and extra high voltage (EHV) cable applications, the electrical properties of the polymer composition used in the cable have significant importance.

Raising the voltage level of HVDC power cables offer the possibility to either increase the power transmission capacity and/or reduce losses. In HVDC cables, the insulation is partly heated by the leakage current through the insulation. For a given cable design, this heating is proportional to the insulation conductivity×voltage². Thus, if the voltage is increased, more heat will be generated. This, may lead to thermal runaway followed by electric breakdown. Thus, in order to further increase the voltage level of HVDC cables, insulation materials with lower electrical conductivity are needed.

A typical power cable comprises a conductor surrounded, at least, by an inner semiconductive layer, an insulation layer and an outer semiconductive layer, in that order. The cables are commonly produced by extruding the layers onto a conductor.

The polymer material in one or more of said layers is often crosslinked to improve e.g. heat and deformation resistance, creep properties, mechanical strength, chemical resistance and abrasion resistance. During the crosslinking reaction, crosslinks (bridges) are primarily formed. Crosslinking can be effected using e.g. a free radical generating compound which is typically incorporated into the layer material prior to the extrusion of the layer(s) on a conductor. After formation of the layered cable, the cable is then subjected to a crosslinking step to initiate the radical formation and thereby crosslinking reaction.

Peroxides are very commonly used as free radical generating compounds. Crosslinking using peroxides suffers from some disadvantages, however. For example low-molecular by-products are formed during crosslinking which have an unpleasant odour. These decomposition products of peroxides may include volatile by-products which are often undesired, since they may have a negative influence on the electrical properties of the cable. Therefore the volatile decomposition products such as methane are conventionally reduced to a minimum or removed after crosslinking and a cooling step. Such a removal step, generally known as a degassing step, is time and energy consuming causing extra costs.

Thermoplastic LDPE can offer several advantages compared to a thermosetting cross-linked PE, such as no possibility of peroxide initiated scorch and no degassing step is required to remove peroxide decomposition products. The elimination of crosslinking and degassing steps can lead to faster, less complicated and more cost effective cable production. The process is faster and cleaner (in terms of extruder output and reduced cleaning interruptions). The absence of peroxide at high temperature vulcanisation is also attractive from a safety perspective. Thermoplastics are also beneficial from a recycling point of view. However, the absence of a cross-linked material can lead to a reduced dimensional stability at elevated temperatures.

Thus, there is a need for new polyolefin compositions which avoid the disadvantages associated with peroxides, but which also offer attractive properties. Hence, it is the object of the present invention to provide a new polyolefin composition which can provide such properties suitable for use in cable applications without using peroxide at all.

The possibility of using non cross-linked LDPE in the insulation layer of a cable is not new. In WO2011/113685, LDPE of density 922 kg/m³ and MFR₂ 1.90 g/10 min is suggested for use in the insulation layer of a cable. WO2011/113685 also suggests using other polymers individually in the non cross-linked insulation layer of a cable.

WO2017/220608 describes the combination of LDPE and HDPE or an ultra-high molecular weight polyethylene having a Mw of at least 1,000,000 in the insulation layer of a cable.

WO2017/220616 describes the combination of low density polyethylene (LDPE); and a conjugated aromatic polymer in the insulation layer of a cable.

The combination of an LDPE with two polyolefins: one comprising epoxy groups and the other comprising carboxylic acid groups, or precursors thereof is discussed in WO2020/229658 and WO2020/229659.

WO2020/229657 describes a polyolefin composition comprising a polyolefin (A) comprising epoxy groups and a polyolefin (B) comprising carboxylic acid groups and/or precursors thereof, with the proviso that one of polyolefin (A) and polyolefin (B) is a low density polyethylene (LDPE) and the other of polyolefin (A) and polyolefin (B) is a polypropylene.

Angewandte Makromoleculare Chemie, Applied Macromolecular chemistry and physics, vol. 270, no. 1 p 28-32 describes certain blends of LDPE, polypropylene and polystyrene.

CN108384106 describes a flame-retardant cable material comprising (in parts by weight): 60-85 parts of polypropylene, 10-35 parts of SEBS resin, 2-8 parts of LDPE, 5-15 parts of maleic anhydride grafted polypropylene, 0.2-1.0 part of pentaerythritol stearate, 1-6 parts of magnesium stearate, 20-35 parts of light calcium carbonate, 15-25 parts of magnesium hydroxide, 5-10 parts of modified hydrotalcite, and 10-20 parts of modified ammonium polyphosphate.

US2018/032781 describes a composition in which LDPE is combined with polypropylene and optionally a compatibiliser. The compatibiliser used is a styrene ethylene propylene block copolymer.

EP3739001 describes a composition comprising LDPE, a PP homopolymer and a random heterophasic polypropylene.

The present inventors have now found that the combination of a LDPE and a polypropylene and optionally a styrene block copolymer provides a composition which is ideally suited for cable manufacture and advantageously does not require the use of peroxide. Surprisingly, these blends have lower DC conductivity than the corresponding LDPE. The mechanical properties of the blend are also good. Hence it is demonstrated that the blends of LDPE and polypropylene can be used in cable layers without the need for a crosslinking reaction to make the layer thermosetting.

### SUMMARY OF INVENTION

Thus, viewed from one aspect the invention provides a cable, preferably a power cable, comprising one or more conductors surrounded by at least one layer, wherein said layer comprises:
(i) 15 to 84.5 wt % low density polyethylene (LDPE);
(ii) a polypropylene; and
(iii) a styrene block copolymer;
wherein the weight percentages are based on the layer as a whole.

Alternatively viewed, the invention provides a cable, preferably a power cable, comprising one or more conductors surrounded by at least one layer, wherein said layer consists of a polymer composition comprising:
(i) 15 to 84.5 wt % low density polyethylene (LDPE);
(ii) a polypropylene; and
(iii) a styrene block copolymer;
wherein the weight percentages are based on the polymer composition as a whole.

It will be appreciated that these two statements of invention define the same subject matter.

Viewed from another aspect the invention provides a polymer composition comprising
(i) 4.0 to 95.5 wt % low density polyethylene (LDPE);
(ii) 4.0 to 95.5 wt % of a polypropylene; and
(iii) 0.5 to 20 wt % of a styrene block copolymer.

It will be appreciated that the weight percent ranges in the embodiment above are based on the weight of the component in question in the polymer composition as a whole.

Viewed from another aspect, the invention provides a cable, such as a power cable, comprising one or more conductors surrounded by at least one layer, preferably at least an insulation layer, wherein said layer comprises, such as consists of, a polymer composition comprising
(i) 4.0 to 95.5 wt % LDPE;
(ii) 4.0 to 95.5 wt % of a polypropylene; and
(iii) 0.5 to 20 wt % of a styrene block copolymer.

It will be appreciated that the weight percent ranges in the embodiment above are based on the weight of the component in question in the polymer composition as a whole.

Viewed from another aspect, the invention provides a cable, such as a power cable comprising one or more conductors surrounded by at least one layer, preferably at least an insulation layer, wherein said layer comprises, preferably consists essentially of,
(i) 60 to 95 wt % LDPE; and
(ii) 5 to 40 wt % of a polypropylene.

It will be appreciated that the weight percent ranges in the embodiment above are based on the weight of the component in question in the layer as a whole.

Viewed from a further aspect, the invention provides a process for the preparation of a polymer composition as hereinbefore defined comprising compounding:
(i) 4.0 to 95.5 wt % LDPE;
(ii) 4.0 to 95.5 wt % of a polypropylene; and
(iii) 0.5 to 20 wt % of a styrene block copolymer.

The invention also provides a process for producing a cable comprising the steps of: applying on one or more conductors, a layer comprising a polymer composition as hereinbefore defined.

Viewed from one aspect the invention provides the use of a polymer composition as hereinbefore defined in the manufacture of an insulation layer in a cable, preferably a power cable.

Viewed from another aspect, the invention provides the use of a polymer composition as hereinbefore defined in the manufacture of a recycled insulation layer in a cable, preferably a power cable.

### Definitions

Wherever the term “molecular weight Mw” is used herein, the weight average molecular weight is meant.

The term “polyethylene” will be understood to mean an ethylene based polymer, i.e. one comprising at least 50 wt % ethylene, based on the total weight of the polymer as a whole. The terms “polyethylene” and “ethylene-based polymer,” are used interchangeably herein, and men a polymer that comprises a majority weight percent polymerized ethylene monomer (based on the total weight of polymerisable monomers), and optionally may comprise at least one polymerised comonomer. The ethylene-based polymer may include greater than 50, or greater than 60, or greater than 70, or greater than 80, or greater than 90 weight percent units derived from ethylene (based on the total weight of the ethylene-based polymer).

The term “polypropylene” will be understood to mean a propylene based polymer, i.e. one comprising at least 50 wt % propylene, based on the total weight of the polymer as a whole.

The term styrene block copolymer defines a block copolymer comprising several blocks where each block is made with the same type of monomer (or mixture of monomers), but the type of monomer(s) differs between blocks.

Non cross-linked polymer compositions or cable layers are regarded as thermoplastic.

The polymer composition of the invention may also be referred to as a polymer blend herein. These terms are used interchangeably.

The low density polyethylene, LDPE, of the invention is a polyethylene produced in a high pressure process. Typically the polymerization of ethylene and optional further comonomer(s) in a high pressure process is carried out in the presence of an initiator(s). The meaning of the term LDPE is well known and documented in the literature. The term LDPE describes and distinguishes a high pressure polyethylene from low pressure polyethylenes produced in the presence of an olefin polymerisation catalyst. LDPEs have certain typical features, such as different branching architecture. A typical density range for an LDPE is 0.910 to 0.940 g/cm³.

The term “conductor” means herein a conductor comprising one or more wires. The wire can be for any use and be e.g. optical, telecommunication or electrical wire. Moreover, the cable may comprise one or more such conductors. Preferably the conductor is an electrical conductor and comprises one or more metal wires.

### DETAILED DESCRIPTION OF THE INVENTION

In a first embodiment, the present invention relates to a particular polymer composition comprising (i) an LDPE, (ii) a polypropylene, and (iii) a styrene block copolymer as well as to a cable having a layer consisting of this composition.

The invention also relates to cables in which at least one layer thereof comprises or consists of this polymer composition. Alternatively, the invention relates to a cable in which one layer therefore, preferably the insulation layer comprises LDPE and polypropylene in the absence of the styrene block copolymer. In all embodiments, the polymer composition or the layer of the cable in question is ideally free of peroxide.

The styrene block copolymer used herein is primarily used as a compatibiliser to aid the mixing of the LDPE and polypropylene components. The styrene block copolymer reduces phase separation, and results in blends with advantageous thermomechanical properties. Moreover, the inclusion of the styrene block copolymer also offers reduced DC conductivity.

The lower DC conductivity may allow higher operating temperature of power cables, which in principle can allow higher transmission capacity.

The following preferred definitions of LDPE, polypropylene and styrene block copolymer apply to all aspects of the invention unless otherwise stated.

Any percentages apply to the polymer composition or the content of polymer components in the layer in question.

### LDPE

The low density polyethylene (LDPE) is an ethylene-based polymer. The term, “ethylene-based polymer,” as used herein, is a polymer that comprises a majority weight percent polymerized ethylene monomer (based on the total weight of polymerisable monomers), and optionally may comprise at least one polymerised comonomer. The ethylene-based polymer may include greater than 50, or greater than 60, or greater than 70, or greater than 80, or greater than 90 weight percent units derived from ethylene (based on the total weight of the ethylene-based polymer).

The LDPE may be a low density homopolymer of ethylene (referred herein as LDPE homopolymer) or a low density copolymer of ethylene with one or more comonomer(s) (referred herein as LDPE copolymer). The one or more comonomers of the LDPE copolymer are preferably selected from the polar comonomer(s), non-polar comonomer(s) or from a mixture of the polar comonomer(s) and non-polar comonomer(s). Moreover, said LDPE homopolymer or LDPE copolymer may optionally be unsaturated. Preferably, the LDPE is a homopolymer.

As a polar comonomer for the LDPE copolymer comonomer(s) containing hydroxyl group(s), alkoxy group(s), carbonyl group(s), carboxyl group(s), ether group(s) or ester group(s), or a mixture thereof, can be used. More preferably, comonomer(s) containing carboxyl and/or ester group(s) are used as said polar comonomer. Still more preferably, the polar comonomer(s) of the LDPE copolymer is selected from the groups of acrylate(s), methacrylate(s) or acetate(s), or any mixtures thereof.

If present in said LDPE copolymer, the polar comonomer(s) is preferably selected from the group of alkyl acrylates, alkyl methacrylates or vinyl acetate, or a mixture thereof. Further preferably, said polar comonomers are selected from C₁- to C₆-alkyl acrylates, C₁- to C₆-alkyl methacrylates or vinyl acetate. Still more preferably, said LDPE copolymer is a copolymer of ethylene with C₁- to C₄-alkyl acrylate, such as methyl, ethyl, propyl or butyl acrylate, or vinyl acetate, or any mixture thereof.

The non-polar comonomer(s) for the LDPE copolymer are preferably selected from monounsaturated (=one double bond) comonomer(s), (such as alpha-olefins, more preferably C₃ to C₁₀ alpha-olefins, such as propylene, 1-butene, 1-hexene, 4-methyl-1-pentene, styrene, 1-octene, 1-nonene); polyunsaturated (=more than one double bond) comonomer(s); a silane group containing comonomer(s); or any mixtures thereof. The polyunsaturated comonomer(s) are further described below.

If the LDPE is a copolymer, it preferably comprises 0.001 to 35 wt.-%, still more preferably less than 30 wt.-%, more preferably less than 25 wt.-%, of one or more comonomer(s). Preferred ranges include 0.5 to 10 wt %, such as 0.5 to 5 wt % comonomer.

The LDPE polymer, may optionally be unsaturated, i.e. may comprise carbon-carbon double bonds (—C═C—). Preferred “unsaturated” LDPEs contains carbon-carbon double bonds/1000 carbon atoms in a total amount of at least 0.4/1000 carbon atoms. If a non-cross-linked LDPE is used in the final cable, then the LDPE is typically not unsaturated as defined above. By not unsaturated is meant that the C═C content is preferably less than 0.2/1000 carbon atoms, such as 0.1/1000 C atoms or less.

As well known, the unsaturation can be provided to the LDPE polymer by means of the comonomers, a low molecular weight (Mw) additive compound, such as a chain transfer agent or scorch retarder additive, or any combinations thereof. The total amount of double bonds means herein double bonds added by any means. If two or more above sources of double bonds are chosen to be used for providing the unsaturation, then the total amount of double bonds in the LDPE polymer means the sum of the double bonds present. Any double bond measurements are carried out prior to optional crosslinking.

The term “total amount of carbon-carbon double bonds” refers to the combined amount of double bonds which originate from vinyl groups, vinylidene groups and trans-vinylene groups, if present.

If an LDPE homopolymer is unsaturated, then the unsaturation can be provided e.g. by a chain transfer agent (CTA), such as propylene, and/or by polymerization conditions. If an LDPE copolymer is unsaturated, then the unsaturation can be provided by one or more of the following means: by a chain transfer agent (CTA), by one or more polyunsaturated comonomer(s) or by polymerisation conditions. It is well known that selected polymerisation conditions such as peak temperatures and pressure, can have an influence on the unsaturation level. In case of an unsaturated LDPE copolymer, it is preferably an unsaturated LDPE copolymer of ethylene with at least one polyunsaturated comonomer, and optionally with other comonomer(s), such as polar comonomer(s) which is preferably selected from acrylate or acetate comonomer(s). More preferably an unsaturated LDPE copolymer is an unsaturated LDPE copolymer of ethylene with at least polyunsaturated comonomer(s).

The polyunsaturated comonomers suitable as the non polar comonomer preferably consist of a straight carbon chain with at least 8 carbon atoms and at least 4 carbons between the non-conjugated double bonds, of which at least one is terminal, more preferably, said polyunsaturated comonomer is a diene, preferably a diene which comprises at least eight carbon atoms, the first carbon-carbon double bond being terminal and the second carbon-carbon double bond being non-conjugated to the first one. Preferred dienes are selected from C₈ to C₁₄ non-conjugated dienes or mixtures thereof, more preferably selected from 1,7-octadiene, 1,9-decadiene, 1,11-dodecadiene, 1,13-tetradecadiene, 7-methyl-1,6-octadiene, 9-methyl-1,8-decadiene, or mixtures thereof. Even more preferably, the diene is selected from 1,7-octadiene, 1,9-decadiene, 1,11-dodecadiene, 1,13-tetradecadiene, or any mixture thereof, however, without limiting to above dienes.

It is well known that e.g. propylene can be used as a comonomer or as a chain transfer agent (CTA), or both, whereby it can contribute to the total amount of the carbon-carbon double bonds, preferably to the total amount of the vinyl groups. Herein, when a compound which can also act as comonomer, such as propylene, is used as CTA for providing double bonds, then said copolymerisable comonomer is not calculated to the comonomer content.

If LDPE polymer is unsaturated, then it has preferably a total amount of carbon-carbon double bonds, which originate from vinyl groups, vinylidene groups and trans-vinylene groups, if present, of more than 0.4/1000 carbon atoms, preferably of more than 0.5/1000 carbon atoms. The upper limit of the amount of carbon-carbon double bonds present in the LDPE is not limited and may preferably be less than 5.0/1000 carbon atoms, preferably less than 3.0/1000 carbon atoms.

If the LDPE is unsaturated LDPE as defined above, it contains preferably at least vinyl groups and the total amount of vinyl groups is preferably higher than 0.05/1000 carbon atoms, still more preferably higher than 0.08/1000 carbon atoms, and most preferably of higher than 0.11/1000 carbon atoms. Preferably, the total amount of vinyl groups is of lower than 4.0/1000 carbon atoms, more preferably lower than 2.0/1000 carbon atoms. More preferably the LDPE contains vinyl groups in total amount of more than 0.20/1000 carbon atoms, still more preferably of more than 0.30/1000 carbon atoms.

It is however, preferred if the LDPE of the invention is not unsaturated and possesses less than 0.2 C═C/1000 C atoms, preferably less than 0.1 C═C/1000 C atoms. It is also preferred if the LDPE is a homopolymer. As the polymer composition of the invention is not designed for crosslinking, the presence of unsaturation within the LDPE is not required or desired.

The LDPE polymer may have a high melting point, which may be of importance especially for a thermoplastic insulation material. Melting points of 112° C. or more are envisaged, such as 114° C. or more, especially 116° C. or more, such as 112 to 130° C.

The LDPE may have a density of 915 to 940 kg/m³, preferably 918 to 935 kg/m³, especially 920 to 932 kg/m³, such as about 922 to 930 kg/m³.

The MFR₂ (2.16 kg, 190° C.) of the LDPE is preferably from 0.05 to 30.0 g/10 min, more preferably is from 0.1 to 20 g/10 min, and most preferably is from 0.1 to 10 g/10 min, especially 0.1 to 5.0 g/10 min. In a preferred embodiment, the MFR₂ of the LDPE is 0.1 to 4.0 g/10 min, especially 0.5 to 4.0 g/10 min, especially 1.0 to 3.0 g/10 min.

The LDPE may have an Mw of 80 kg/mol to 200 kg/mol, such as 100 to 180 kg/mol.

It is possible to use a mixture of LDPEs in the polymer composition or cable layer of the invention however it is preferred if a single LDPE is used. If a mixture of LDPEs is used then the wt % quoted refer to the total LDPE content present.

The LDPE polymer is produced at high pressure by free radical initiated polymerisation (referred to as high pressure (HP) radical polymerization). The HP reactor can be e.g. a well-known tubular or autoclave reactor or a mixture thereof, preferably a tubular reactor. The high pressure (HP) polymerisation and the adjustment of process conditions for further tailoring the other properties of the LDPE depending on the desired end application are well known and described in the literature, and can readily be used by a skilled person. Suitable polymerisation temperatures range up to 400° C., preferably from 80 to 350° C. and pressure from 70 MPa, preferably 100 to 400 MPa, more preferably from 100 to 350 MPa. Pressure can be measured at least after compression stage and/or after the tubular reactor. Temperature can be measured at several points during all steps.

After the separation the obtained LDPE is typically in a form of a polymer melt which is normally mixed and pelletized in a pelletising section, such as pelletising extruder, arranged in connection to the HP reactor system. Optionally, additive(s), such as antioxidant(s), can be added in this mixer in a known manner.

Further details of the production of ethylene (co)polymers by high pressure radical polymerization can be found i.a. in the Encyclopedia of Polymer Science and Engineering, Vol. 6 (1986), pp 383-410 and Encyclopedia of Materials: Science and Technology, 2001 Elsevier Science Ltd.: “Polyethylene: High-pressure, R. Klimesch, D. Littmann and F.-O. Mähling pp. 7181-7184.

It is most preferred if the LDPE is a low density homopolymer of ethylene.

The LDPE in the polymer composition of the invention is preferably present in an amount of 4.0 to 95.5 wt %, preferably 8.0 to 90 wt %, such as 15 to 84.5 wt %, or 15 to 80 wt %, preferably 15 to 60 wt %, more preferably 15 to 50 wt %. especially 15 to 30 wt % relative to the total weight of the composition as a whole. In one embodiment there may be 15 to 95.5 wt % of the LDPE in the polymer composition.

The LDPE in the cable layer of the invention is present in an amount of 15 to 84.5 wt %, or 15 to 80 wt %, preferably 15 to 60 wt %, more preferably 15 to 50 wt %, especially 15 to 30 wt % relative to the total weight of the layer as a whole.

In a second embodiment, LDPE and polypropylene are used in at least one layer of a cable, e.g. in the absence of the styrene block copolymer.

In such a cable, it is preferred if at least one layer therefore comprises 60 wt % to 95 wt % of the LDPE, such as 70 to 95 wt %, more preferably 70 to 92.5 wt % of the layer. These weight percentages are based on the weight of the layer as a whole.

The LDPE of the invention is not new. For example, Borealis grade LE6222 is suitable for use in the present invention.

### Polypropylene

The polypropylene is a propylene based polymer. The term, “propylene-based polymer,” as used herein, is a polymer that comprises a majority weight percent polymerized propylene monomer (based on the total weight of polymerisable monomers), and optionally may comprise at least one polymerised comonomer. The propylene-based polymer may include greater than 50, or greater than 60, or greater than 70, or greater than 80, or greater than 90 weight percent units derived from propylene (based on the total weight of the propylene-based polymer).

The polypropylene may be a propylene homopolymer or a propylene copolymer. Preferably, the polypropylene is a homopolymer. Ideally, the polypropylene is not a random heterophasic polypropylene copolymer.

The comonomer may be α-olefin such as ethylene or a C₄₋₂₀ linear, branched or cyclic α-olefin. Nonlimiting examples of suitable C₄₋₂₀ α-olefins include 1-butene, 4-methyl-1-pentene, 1-hexene, 1-octene, 1-decene, 1-dodecene, 1-tetradecene, 1-hexadecene, and 1-octadecene. The α-olefins also can contain a cyclic structure such as cyclohexane or cyclopentane, resulting in an α-olefin such as 3-cyclohexyl-1-propene (allyl cyclohexane) and vinyl cyclohexane. Although not α-olefins in the classical sense of the term, for purposes of this disclosure certain cyclic olefins, such as norbornene and related olefins, particularly 5-ethylidene-2-norbornene, are α-olefins and can be used in place of some or all of the α-olefins described above. Similarly, styrene and its related olefins (for example, α-methylstyrene, etc.) are α-olefins for purposes of this disclosure. Illustrative propylene polymers include ethylene/propylene, propylene/butene, propylene/1-hexene, propylene/1-octene, propylene/styrene, and the like. Illustrative terpolymers include ethylene/propylene/1-octene, ethylene/propylene/butene, propylene/butene/1-octene, ethylene/propylene/diene monomer (EPDM) and propylene/butene/styrene. The copolymers can be random copolymers.

In a particularly preferred embodiment, the polypropylene is a homopolymer such as a syndiotactic, or most preferably, an isotactic propylene homopolymer. The isotactic propylene homopolymer used may be one that is capacitor grade.

Typically, the polypropylene has an MFR₂ of from 0.1 to 100 g/10 min, preferably from 0.5 to 50 g/10 min as determined in accordance with ISO 1133 (at 230° C.; 2.16 kg load). Most preferably, the MFR₂ is in the range of 1.0 to 5.0 g/10 min, such as 1.5 to 4.0 g/10 min.

The density of the polypropylene may typically be in the range 890 to 940 kg/m³, ideally 0.895 to 0.920 g/cm³, preferably from 0.900 to 0.915 g/cm³, and more preferably from 0.905 to 0.915 g/cm³ as determined in accordance with ISO 1183.

The propylene may have an Mw in the range of 200 kg/mol to 600 kg/mol. The polypropylene polymer preferably has a molecular weight distribution Mw/Mn, being the ratio of the weight average molecular weight Mw and the number average molecular weight Mn, of less than 4.5, such as 2 0.0 to 4.0, e.g. 3.0.

Usually the melting temperature of the polypropylene is within the range of 135 to 170° C., preferably in the range of 140 to 168° C., more preferably in the range from 142 to 166° C. as determined by differential scanning calorimetry (DSC) according to ISO 11357-3. Ideally, the polypropylene has a melting temperature (Tm) of greater than 140° C., preferably greater than 150° C.

The polypropylene may be prepared by any suitable known method in the art or can be obtained commercially.

It is possible to use a mixture of polypropylenes in the polymer composition or cable layer of the invention however it is preferred if a single polypropylene is used. If a mixture of polypropylenes is used then the wt % quoted refer to the total polypropylene content present.

In polymer compositions of the invention, the polypropylene (ii) is preferably present in an amount of 4.0 to 95.5 wt %, preferably 8.0 to 90 wt %, such as 15 to 84.5 wt % or 15 to 80 wt %, preferably 30 to 80 wt %, more preferably 50 to 80 wt % relative to the total weight of the polymer composition as a whole.

In one embodiment there may be 4.0 to 84.5 wt % of the polypropylene in the polymer composition.

In the cable layer of the invention, the polypropylene (ii) is preferably present in an amount of 15 to 84.5 wt % or 15 to 80 wt %, preferably 30 to 80 wt %, more preferably 50 to 80 wt % relative to the total weight of the layer as a whole.

In one embodiment there may be 4.0 to 84.5 wt % of the polypropylene in the cable layer.

In a second embodiment, LDPE and polypropylene are used in at least one layer of a cable, e.g. in the absence of the styrene block copolymer. In such a cable, it is preferred if at least one layer thereof comprises 5 wt % to 40 wt % polypropylene, such as 5 to 30 wt %, more preferably 7.5 to 30 wt % of the layer in which it is present.

These polymers are readily available from polymer suppliers.

Where a styrene block copolymer is present, it is preferred if the combined amount of the polypropylene and the LDPE components in the polymer composition is 85 to 99.0 wt %, such as 90 to 98 wt %.

Where a styrene block copolymer is present, it is preferred if the combined amount of the polypropylene and the LDPE components in the cable layer is 85 to 99.0 wt %, such as 90 to 98 wt %.

### Styrene Block Copolymer

The styrene block copolymer is a block copolymer comprising styrene monomers and one or more other comonomer(s). The term “block copolymer” will be well known to the skilled person to refer to a copolymer comprising blocks of different polymerised monomers. A block copolymer comprises a plurality of blocks where each block is made with the same type of monomer (or mixture of monomers), but the type of monomer(s) differs between blocks.

The comonomer(s) may be monounsaturated (=one double bond) comonomer(s), preferably olefins, more preferably alpha-olefins, even more preferably C₂ to C₁₀ alpha-olefins, such as ethylene, propylene, 1-butene, 1-hexene, 4-methyl-1-pentene, 1-octene, 1-nonene; polyunsaturated (=more than one double bond) comonomer(s), preferably consisting of a straight or branched carbon chain with at least 4 carbon atoms and at least one terminal double bond, more preferably a diene, such as butadiene or isoprene; or mixtures thereof.

In one embodiment, the styrene block copolymer is a terpolymer, i.e. comprising three different monomers (styrene together with two different comonomers).

It is especially preferred that the styrene block copolymer is selected from the group consisting of a styrene-ethylene/butylene-styrene (SEBS) block copolymer, a styrene-ethylene/propylene-styrene (SEPS) block copolymer, a styrene-butadiene-styrene (SBS) block copolymer and a styrene-isoprene-styrene (SIS) block copolymer or mixtures thereof. Most preferably, the styrene block copolymer is a styrene-ethylene/butylene-styrene (SEBS) block copolymer.

The styrene block copolymer may have a styrene content of equal or below 40 wt.-%, more preferably of equal or below 35 wt-%, yet more preferably of equal or below 30 wt.-%. On the other hand the styrene content in the styrene block copolymer, should not fall below 10 wt.-%. Thus a preferred range is of 10 to 40 wt.-%, more preferred of 12 to 35 wt.-% and yet more preferred of 15 to 30 wt.-%.

Further it is appreciated that the styrene block copolymer preferably has a melt flow rate MFR₅ (230° C./5.0 kg) of at least 0.1 g/10 min, more preferably of at least 0.2 g/10 min, still more preferably of at least 0.5 g/10 min. On the other hand the melt flow rate MFR₅ (230° C./5.0 kg) of the styrene block copolymer is preferably not more than 30 g/10 min. Accordingly, a preferred melt flow rate MFR₅ (230° C./5.0 kg) is in the range of 0.1 to 30 g/10 min, more preferred of 0.2 to 25 g/10 min, still more preferred of 0.5 to 20 g/10 min.

The styrene block copolymer may also be defined by its density, which is preferably equal or below 0.950 g/cm³, more preferred equal or below 0.940 g/cm³. Typically, the density of the styrene block copolymer is at least 0.900 g/cm³, more preferred equal or below 0.910 g/cm³.

The styrene block copolymer may be prepared by any suitable known method in the art or can be obtained commercially.

The styrene block copolymer (iii) may be present in an amount of 0.5 to 20 wt %, preferably 1.0 to 15 wt %, such as 2.0 to 10 wt %, more preferably 3.0 to 8.0 wt %, such as 5 wt % based on the total weight of the polymer composition as a whole. If a mixture of styrene block copolymers is used then these percentages refer to the total amount of all styrene block copolymers.

The styrene block copolymer (iii) may be present in an amount of 0.5 to 20 wt %, preferably 1.0 to 15 wt %, such as 2.0 to 10 wt %, more preferably 3.0 to 8.0 wt %, such as 5 wt % based on the total weight of the cable layer as a whole. If a mixture of styrene block copolymers is used then these percentages refer to the total amount of all styrene block copolymers.

These polymers are readily available from polymer suppliers

### Polymer Composition/Cable Layer

Whilst it is within the ambit of the invention for the polymer composition or cable layer to comprise other polymer components in addition to the LDPE, polypropylene and the styrene block copolymer, it is preferable if the composition or cable layer consists essentially of the LDPE, polypropylene and styrene block copolymer as the only polymer components. It will be appreciated that the polymer composition or cable layer may further contain standard polymer additives discussed in more detail below. The term consists essentially of implies therefore the exclusion of any other polymer component but allows for the presence of additives (which may be part of a masterbatch).

In a preferred embodiment, the invention provides a polymer composition comprising
(i) 15 to 95.5 wt % low density polyethylene (LDPE);
(ii) 4.0 to 84.5 wt % of a polypropylene; and
(iii) 0.5 to 20 wt % of a styrene block copolymer.

In a preferred embodiment, the invention provides a polymer composition or cable layer comprising
(i) 15 to 84.0 wt % low density polyethylene (LDPE);
(ii) 15 to 84.0 wt % of a polypropylene; and
(iii) 1.0 to 15 wt % of a styrene block copolymer.

In a preferred embodiment, the invention provides a polymer composition or cable layer comprising
(i) 15 to 80 wt % LDPE;
(ii) 15 to 80 wt % of a polypropylene; and
(iii) 2.0 to 10 wt % of a styrene block copolymer.

In a preferred embodiment, the invention provides a polymer composition or cable layer comprising
(i) 15 to 80 wt % LDPE homopolymer;
(ii) 15 to 80 wt % of a polypropylene homopolymer; and
(iii) 2.0 to 10 wt % of a styrene block copolymer.

In a preferred embodiment, the invention provides a polymer composition or cable layer comprising
(i) 15 to 80 wt % LDPE homopolymer;
(ii) 15 to 80 wt % of a polypropylene homopolymer; and
(iii) 2.0 to 10 wt % of a poly[styrene-b-(ethylene-co-butylene)-b-styrene](SEBS), Poly[styrene-b-(ethylene-co-propylene)-b-styrene] (SEPS), Poly[styrene-b-(butadiene)-b-styrene] (SBS) and Poly[styrene-b-(isoprene)-b-styrene] (SIS), preferably SEBS.

In a further preferred embodiment, the invention provides a polymer composition or cable layer comprising
(i) 15 to 50 wt % LDPE;
(ii) 40 to 80 wt % of a polypropylene; and
(iii) 3.0 to 8.0 wt % of a styrene block copolymer.

In a further preferred embodiment, the invention provides a polymer composition or cable layer comprising
(i) 15 to 50 wt % LDPE homopolymer;
(ii) 40 to 80 wt % of a polypropylene homopolymer; and
(iii) 3.0 to 8.0 wt % of a styrene block copolymer.

In a preferred embodiment, the invention provides a polymer composition or cable layer comprising
(i) 15 to 50 wt % LDPE homopolymer;
(ii) 40 to 80 wt % of a polypropylene homopolymer; and
(iii) 3.0 to 8.0 wt % of a poly[styrene-b-(ethylene-co-butylene)-b-styrene](SEBS), Poly[styrene-b-(ethylene-co-propylene)-b-styrene] (SEPS), Poly[styrene-b-(butadiene)-b-styrene] (SBS) and Poly[styrene-b-(isoprene)-b-styrene] (SIS), preferably SEBS.

In any of the above embodiments the use of peroxide with the undesired problems as discussed above can be markedly reduced or completely avoided. Hence, the polymer composition or cable layer of the invention is preferably substantially free of peroxide (e.g. comprises less than 0.5 wt % peroxide, preferably less than 0.1 wt % peroxide, such as less than 0.05 wt % peroxide, relative to the total weight of the composition). Even more preferably, the polymer composition or cable layer is free of any peroxide (i.e. contains 0 wt % peroxide, relative to the total weight of the composition) and most preferably free of any radical forming agent.

In one embodiment, the composition is thermoplastic. Thus, the composition of the invention is preferably not crosslinked.

The polymer composition or cable layer of the invention preferably has a DC conductivity of 0.5 to 10 fS/m when measured after 24 hrs at 30 kV/mm and a temperature of 70° C., preferably 0.5 to 6.0 fS/m.

During manufacture of the composition or cable layer, the components can be blended, e.g. melt mixed in an extruder.

Typically, said process will be carried out by compounding by, for example, extrusion. Preferably, said process does not involve the use of peroxide. As a result of this the process for preparing the polymer composition or cable layer of the invention typically does not comprise a degassing step.

Typically, the process involves heating to a temperature of at least 150° C., preferably at least 160° C., such as at least 170° C. The process will generally involve heating to 300° C. or less, such as 250° C. or less.

### Cable

The cable of the invention is typically a power cable, such as an AC cable or a DC cable. A power cable is defined to be a cable transferring energy operating at any voltage level, typically operating at voltages higher than 1 kV. The power cable can be a low voltage (LV), a medium voltage (MV), a high voltage (HV) or an extra high voltage (EHV) cable, which terms, as well known, indicate the level of operating voltage.

The polymer composition is even more preferably used in the insulation layer for a DC power cable operating at voltages higher than 36 kV, such as a HV DC cable. For HV DC cables the operating voltage is defined herein as the electric voltage between ground and the conductor of the high voltage cable.

Preferably the HV DC power cable of the invention is one operating at voltages of 40 kV or higher, even at voltages of 50 kV or higher. More preferably, the HV DC power cable operates at voltages of 60 kV or higher. The invention is also highly feasible in very demanding cable applications and further cables of the invention are HV DC power cable operating at voltages higher than 70 kV. Voltages of 100 kV or more are targeted, such as 200 kV or more, more preferably 300 kV or more, especially 400 kV or more, more especially 500 kV or more. Voltages of 640 kV or more, such as 700 kV are also envisaged. The upper limit is not limited. The practical upper limit can be up to 1500 kV, such as 1100 kV. The cables of the invention operate well therefore in demanding extra HV DC power cable applications operating 400 to 850 kV, such as 650 to 850 kV.

A cable, such as a power cable (e.g. a DC power cable) comprises one or more conductors surrounded by at least one layer. The polymer composition of the invention may be used in that at least one layer. Preferably, the cable comprises an inner semiconductive layer, an insulation layer and an outer semiconductive layer, in that order.

The polymer composition of the invention is preferably used in the insulation layer of the cable. Ideally, the at least one layer, preferably the insulation layer comprises at least 95 wt %, such as at least 98 wt % of the polymer composition of the invention, such as at least 99 wt %, relative to the total weight of the layer as a whole. Ideally the layer consists of the polymer composition. It is preferred therefore if the polymer composition of the invention is the only non-additive component used in the insulation layer of the cables of the invention. The term consists essentially of is used herein to mean that the only polymer composition present is that defined herein. It will be appreciated that the insulation layer may contain standard polymer additives such as water tree retarders, antioxidants and so on. These are not excluded by the term “consists essentially of”. Note also that these additives may be added as part of a masterbatch and hence carried on a polymer carrier. The use of masterbatch additives is not excluded by the term consists essentially of Such a layer is preferably free of peroxide.

Alternatively viewed therefore, the invention provides a cable, such as a power cable comprising one or more conductors surrounded by at least one layer, preferably at least an insulation layer, wherein said layer comprises
(i) 4.0 to 95.5 wt % LDPE;
(ii) 4.0 to 95.5 wt % of a polypropylene; and
(iii) 0.5 to 20 wt % of a styrene block copolymer.

The cable layer of the invention preferably has a DC conductivity of 0.5 to 10 fS/m when measured after 24 hrs at 30 kV/mm and a temperature of 70° C., preferably 0.5 to 6.0 fS/m.

In a second embodiment the invention provides a cable, such as a power cable comprising one or more conductors surrounded by at least one layer, preferably at least an insulation layer, wherein said layer comprises, preferably consists essentially of,
(i) 60 to 95 wt % LDPE; and
(ii) 5 to 40 wt % of a polypropylene.

In this embodiment, the layer in question may be free of a styrene block copolymer.

It will be appreciated that the weight percent ranges in the embodiment above are based on the weight of the component in question in the layer as a whole.

This cable layer preferably has a DC conductivity of 0.5 to 25 fS/m when measured after 24 hrs at 30 kV/mm and a temperature of 70° C., preferably 3.0 to 25 fS/m.

The insulation layer is preferably not cross-linked. It is preferred if the insulation layer comprises no crosslinking agent. The insulation layer is thus ideally free of peroxides and hence free of by-products of the decomposition of the peroxide.

Naturally, the non cross-linked embodiment also simplifies the cable production process. Also, it is generally required to degas a cross-linked cable layer to remove the by-products of these agents after crosslinking. Where these are absent, no such degassing step is required. Another advantage of not using an external crosslinking agent is the elimination of the health and safety issues associated with the handling and storage of these agents, particularly peroxides.

The insulation layer may contain, in addition to the polymer composition of the invention further component(s) such as additives, e.g. antioxidant(s), scorch retarder(s) (SR), crosslinking booster(s), stabiliser(s), processing aid(s), flame retardant additive(s), water tree retardant additive(s), acid or ion scavenger(s), inorganic filler(s), dielectric liquids and voltage stabilizer(s), as known in the polymer field. Typically, however, no scorch retarder will be present.

The insulation layer may therefore comprise conventionally used additive(s) for W&C applications, such as one or more antioxidant(s). As non-limiting examples of antioxidants e.g. sterically hindered or semi-hindered phenols, aromatic amines, aliphatic sterically hindered amines, organic phosphites or phosphonites, thio compounds, and mixtures thereof, can be mentioned.

Preferably, the insulation layer does not comprise a carbon black. Also preferably, the insulation layer does not comprise flame retarding additive(s), e.g. a metal hydroxide containing additives in flame retarding amounts.

The used amounts of additives are conventional and well known to a skilled person, e.g. 0.1 to 1.0 wt %.

The cable of the invention also typically contains inner and outer semiconductive layers. These can be made of any conventional material suitable for use in these layers. The inner and the outer semiconductive layers can be different or identical and may comprise a polymer(s) which is preferably a polyolefin or a mixture of polyolefins and a conductive filler, preferably carbon black. Suitable polyolefin(s) are e.g. polyethylene produced in a low pressure process (LLDPE, vMDPE, HDPE), polyethylene produced in a HP process (LDPE) or a polypropylene.

In one embodiment, the polymer composition of the invention can be used in the manufacture of the inner and/or outer semiconductive layers.

The inner and outer semiconductive layers may comprise carbon black. The carbon black can be any conventional carbon black used in the semiconductive layers of a power cable, preferably in the semiconductive layer of a power cable. Preferably the carbon black has one or more of the following properties: a) a primary particle size of at least 5 nm which is defined as the number average particle diameter according ASTM D3849-95a, dispersion procedure D b) iodine number of at least 30 mg/g according to ASTM D1510, c) oil absorption number of at least 30 ml/100 g which is measured according to ASTM D2414. Non-limiting examples of carbon blacks are e.g. acetylene carbon black, furnace carbon black and Ketjen carbon black, preferably furnace carbon black and acetylene carbon black. Preferably, the semiconductive layer(s) comprises 10 to 50 wt % carbon black, based on the total weight of the layer.

In one embodiment, the outer semiconductive layer is cross-linked. In another embodiment, the inner semiconductive layer is preferably non-cross-linked. Overall it is preferred if the inner and outer semiconductive layers and the insulation layer remain non cross-linked. It is however possible that the inner semiconductive layer and the insulation layer remain non cross-linked where the outer semiconductive layer is cross-linked. A peroxide crosslinking agent can therefore be provided in the outer semiconductive layer only.

The conductor typically comprises one or more wires. Moreover, the cable may comprise one or more such conductors. Preferably the conductor is an electrical conductor and comprises one or more metal wires. Cu or Al wire is preferred.

As well known the cable can optionally comprise further layers, e.g. screen(s), a jacketing layer(s), other protective layer(s) or any combinations thereof.

### Cable Manufacture

The invention also provides a process for producing a cable comprising the steps of applying on one or more conductors, preferably by (co)extrusion, a layer comprising the polymer composition of the invention or a layer comprising, preferably consisting essentially of,
(i) 60 to 95 wt % LDPE; and
(ii) 5 to 40 wt % of a polypropylene.

It will be appreciated that the weight percent ranges in the embodiment above are based on the weight of the component in question in the layer as a whole.

The invention also provides a process for producing a cable comprising the steps of applying on one or more conductors, preferably by (co)extrusion, an inner semiconductive layer, an insulation layer and an outer semiconductive layer, in that order, wherein the insulation layer comprises the composition of the invention or
(i) 60 to 95 wt % LDPE; and
(ii) 5 to 40 wt % of a polypropylene.

### Cable Manufacture

The invention also provides a process for producing a cable comprising the steps of applying on one or more conductors, preferably by (co)extrusion, an inner semiconductive layer, an insulation layer and an outer semiconductive layer, in that order, wherein the insulation layer comprises the composition of the invention.

The process may optionally comprise the steps of crosslinking one or both of the inner semiconductive layer or outer semiconductive layer, without crosslinking the insulation layer.

More preferably, a cable is produced, wherein the process comprises the steps of
(a)—providing and mixing, preferably melt mixing in an extruder, an optionally crosslinkable first semiconductive composition comprising a polymer, a carbon black and optionally further component(s) for the inner semiconductive layer,
   providing and mixing, preferably melt mixing in an extruder, the polymer composition of the invention; and
   providing and mixing, preferably melt mixing in an extruder, a second semiconductive composition which is optionally crosslinkable and comprises a polymer, a carbon black and optionally further component(s) for the outer semiconductive layer,
(b) applying on one or more conductors, preferably by coextrusion,
   a melt mix of the first semiconductive composition obtained from step (a) to form the inner semiconductive layer,
   a meltmix of polymer composition of the invention obtained from step (a) to form the insulation layer, and
   a meltmix of the second semiconductive composition obtained from step (a) to form the outer semiconductive layer, and
(c) optionally crosslinking at crosslinking conditions one or both of the first semiconductive composition of the inner semiconductive layer and the second semiconductive composition of the outer semiconductive layer, of the obtained cable, without crosslinking the insulation layer.

Preferably in step (c) the second semiconductive polymer composition of the outer semiconductive layer is cross-linked. Also preferably, the second semiconductive polymer composition of the outer semiconductive layer is cross-linked, without crosslinking the insulation layer or the first semiconductive composition of the inner semiconductive layer.

Melt mixing means mixing above the melting point of at least the major polymer component(s) of the obtained mixture and is carried out for example, without limiting to, in a temperature of at least 15° C. above the melting or softening point of polymer component(s).

The term “(co)extrusion” means herein that in case of two or more layers, said layers can be extruded in separate steps, or at least two or all of said layers can be coextruded in a same extrusion step, as well known in the art. The term “(co)extrusion” means herein also that all or part of the layer(s) are formed simultaneously using one or more extrusion heads. For instance a triple extrusion can be used for forming three layers. In case a layer is formed using more than one extrusion heads, then for instance, the layers can be extruded using two extrusion heads, the first one for forming the inner semiconductive layer and the inner part of the insulation layer, and the second head for forming the outer insulation layer and the outer semiconductive layer.

As well known, the polymer composition of the invention and the optional and preferred first and second semiconductive compositions can be produced before or during the cable production process.

Preferably, the polymers required to manufacture the cable of the invention are provided to the cable production process in form of powder, grain or pellets. Pellets mean herein generally any polymer product which is formed from reactor-made polymer (obtained directly from the reactor) by post-reactor modification to a solid polymer particles.

Accordingly, the components can be premixed, e.g. melt mixed together and pelletized, before mixing. Alternatively, and preferably, these components can be provided in separate pellets to the (melt) mixing step (a), where the pellets are blended together.

The (melt) mixing step (a) of the provided polymer composition of the invention and of the preferable first and second semiconductive compositions is preferably carried out in a cable extruder. The step a) of the cable production process may optionally comprise a separate mixing step, e.g. in a mixer arranged in connection and preceding the cable extruder of the cable production line. Mixing in the preceding separate mixer can be carried out by mixing with or without external heating (heating with an external source) of the component(s).

Any crosslinking agent can be added before the cable production process or during the (melt) mixing step (a). For instance, and preferably, the crosslinking agent and also the optional further component(s), such as additive(s), can already be present in the polymers used. The crosslinking agent is added, preferably impregnated, onto the solid polymer particles, preferably pellets.

It is preferred that the melt mix of the polymer composition obtained from (melt)mixing step (a) consists of the LDPE (i), polypropylene (ii) and styrene block copolymer (iii) as the sole polymer components. The optional and preferable additive(s) can be added to polymer composition as such or as a mixture with a carrier polymer, i.e. in a form of a master batch.

The crosslinking of other layers can be carried out at increased temperature which is chosen, as well known, depending on the type of crosslinking agent. For instance temperatures above 150° C., such as from 160 to 350° C., are typical, however without limiting thereto.

The processing temperatures and devices are well known in the art, e.g. conventional mixers and extruders, such as single or twin screw extruders, are suitable for the process of the invention.

The thickness of the insulation layer of the cable, more preferably of the power cable is typically 2 mm or more, preferably at least 3 mm, preferably of at least 5 to 100 mm, more preferably from 5 to 50 mm, and conventionally 5 to 40 mm, e.g. 5 to 35 mm, when measured from a cross section of the insulation layer of the cable.

The thickness of the inner and outer semiconductive layers is typically less than that of the insulation layer, and in power cables can be e.g. more than 0.1 mm, such as from 0.3 up to 20 mm, e.g. 0.3 to 10 mm of inner semiconductive and outer semiconductive layer. The thickness of the inner semiconductive layer is preferably 0.3-5.0 mm, preferably 0.5-3.0 mm, preferably 0.8-2.0 mm. The thickness of the outer semiconductive layer is preferably from 0.3 to 10 mm, such as 0.3 to 5 mm, preferably 0.5 to 3.0 mm, preferably 0.8-3.0 mm. It is evident for and within the skills of a skilled person that the thickness of the layers of the power cable depends on the intended voltage level of the end application cable and can be chosen accordingly.

The cable of the invention is preferably a power cable, preferably a power cable operating at voltages up to 1 kV and known as low voltage (LV) cables, at voltages 1 kV to 36 kV and known as medium voltage (MV) cables, at voltages higher than 36 kV, known as high voltage (HV) cables or extra high voltage (EHV) cables. The terms have well known meanings and indicate the operating level of such cables.

More preferably the cable is a power cable comprising a conductor surrounded by at least an inner semiconductive layer, an insulation layer and an outer semiconductive layer, in that order, wherein at least one layer comprises, preferably consists of, the polymer composition of the invention.

Preferably, the at least one layer is the insulation layer.

The invention will now be described with reference to the following non limiting examples and figures.

### DESCRIPTION OF FIGURES

FIG. 1: plots DC conductivity vs the polypropylene content in the absence of SEBS after 23 and 45 h.

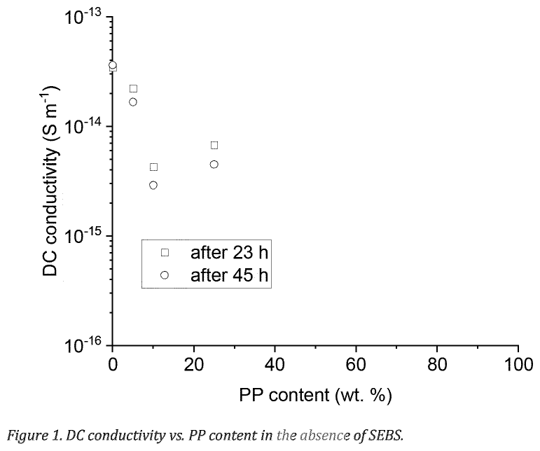

FIG. 2: plots DC conductivity vs the polypropylene content in the presence of SEBS after 23 and 45 h.

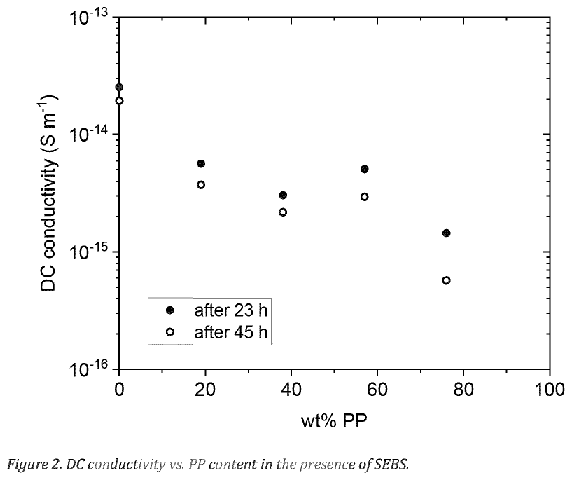

### DETERMINATION METHODS

Unless otherwise stated in the description or claims, the following methods were used to measure the properties defined generally above and in the claims and in the examples below. The samples were prepared according to given standards, unless otherwise stated.

Wt %: % by weight

### Melt Flow Rate

The melt flow rate (MFR) is determined according to ISO 1133 and is indicated in g/10 min. The MFR is an indication of the flowability, and hence the processability, of the polymer. The higher the melt flow rate, the lower the viscosity of the polymer. The MFR is determined at 190° C. for polyethylene and at 230° C. for polypropylene. MFR may be determined at different loadings such as 2.16 kg (MFR₂) or 21.6 kg (MFR₂₁).

### Molecular Weight

Mz, Mw, Mn, and MWD are measured by Gel Permeation Chromatography (GPC) according to the following method:

The weight average molecular weight Mw and the molecular weight distribution (MWD=Mw/Mn wherein Mn is the number average molecular weight and Mw is the weight average molecular weight; Mz is the z-average molecular weight) is measured according to ISO 16014-4:2003 and ASTM D 6474-99. A Waters GPCV2000 instrument, equipped with refractive index detector and online viscosimeter was used with 2×GMHXL-HT and 1×G7000HXL-HT TSK-gel columns from Tosoh Bioscience and 1,2,4-trichlorobenzene (TCB, stabilized with 250 mg/L 2,6-Di tert-butyl-4-methyl-phenol) as solvent at 140° C. and at a constant flow rate of 1 mL/min. 209.5 μL of sample solution were injected per analysis. The column set was calibrated using universal calibration (according to ISO 16014-2:2003) with at least 15 narrow MWD polystyrene (PS) standards in the range of 1 kg/mol to 12 000 kg/mol. Mark Houwink constants were used as given in ASTM D 6474-99. All samples were prepared by dissolving 0.5-4.0 mg of polymer in 4 mL (at 140° C.) of stabilized TCB (same as mobile phase) and keeping for max. 3 hours at a maximum temperature of 160° C. with continuous gentle shaking prior sampling in into the GPC instrument.

### Comonomer Contents

### a) Comonomer Content in Random Copolymer of Polypropylene:

Quantitative Fourier transform infrared (FTIR) spectroscopy was used to quantify the amount of comonomer. Calibration was achieved by correlation to comonomer contents determined by quantitative nuclear magnetic resonance (NMR) spectroscopy.

The calibration procedure based on results obtained from quantitative ¹³C-NMR spectroscopy was undertaken in the conventional manner well documented in the literature.

The amount of comonomer (N) was determined as weight percent (wt %) via:

N=k1(A/R)+k2

wherein A is the maximum absorbance defined of the comonomer band, R the maximum absorbance defined as peak height of the reference peak and with k1 and k2 the linear constants obtained by calibration. The band used for ethylene content quantification is selected depending if the ethylene content is random (730 cm⁻¹) or block-like (as in heterophasic PP copolymer) (720 cm⁻¹). The absorbance at 4324 cm⁻¹ was used as a reference band.

### b) Quantification of Alpha-Olefin Content in Linear Low Density Polyethylenes and Low Density Polyethylenes by NMR Spectroscopy:

The comonomer content was determined by quantitative 13C nuclear magnetic resonance (NMR) spectroscopy after basic assignment (J. Randall JMS—Rev. Macromol. Chem. Phys., C₂₉(2&3), 201-317 (1989). Experimental parameters were adjusted to ensure measurement of quantitative spectra for this specific task.

Specifically solution-state NMR spectroscopy was employed using a Bruker AvanceIII 400 spectrometer. Homogeneous samples were prepared by dissolving approximately 0.200 g of polymer in 2.5 ml of deuterated-tetrachloroethene in 10 mm sample tubes utilising a heat block and rotating tube oven at 140 C. Proton decoupled 13C single pulse NMR spectra with NOE (powergated) were recorded using the following acquisition parameters: a flip-angle of 90 degrees, 4 dummy scans, 4096 transients an acquisition time of 1.6 s, a spectral width of 20 kHz, a temperature of 125 C, a bilevel WALTZ proton decoupling scheme and a relaxation delay of 3.0 s. The resulting FID was processed using the following processing parameters: zero-filling to 32 k data points and apodisation using a gaussian window function; automatic zeroth and first order phase correction and automatic baseline correction using a fifth order polynomial restricted to the region of interest.

Quantities were calculated using simple corrected ratios of the signal integrals of representative sites based upon methods well known in the art.

### c) Comonomer Content of Polar Comonomers in Low Density Polyethylene

### (1) Polymers Containing >6 wt % Polar Comonomer Units

Comonomer content (wt %) was determined in a known manner based on Fourier transform infrared spectroscopy (FTIR) determination calibrated with quantitative nuclear magnetic resonance (NMR) spectroscopy. Below is exemplified the determination of the polar comonomer content of ethylene ethyl acrylate, ethylene butyl acrylate and ethylene methyl acrylate. Film samples of the polymers were prepared for the FTIR measurement: 0.5-0.7 mm thickness was used for ethylene butyl acrylate and ethylene ethyl acrylate and 0.10 mm film thickness for ethylene methyl acrylate in amount of >⁶ wt %. Films were pressed using a Specac film press at 150° C., approximately at 5 tons, 1-2 minutes, and then cooled with cold water in a not controlled manner. The accurate thickness of the obtained film samples was measured.

After the analysis with FTIR, base lines in absorbance mode were drawn for the peaks to be analysed. The absorbance peak for the comonomer was normalised with the absorbance peak of polyethylene (e.g. the peak height for butyl acrylate or ethyl acrylate at 3450 cm⁻¹ was divided with the peak height of polyethylene at 2020 cm⁻¹). The NMR spectroscopy calibration procedure was undertaken in the conventional manner which is well documented in the literature, explained below.

For the determination of the content of methyl acrylate a 0.10 mm thick film sample was prepared. After the analysis the maximum absorbance for the peak for the methylacrylate at 3455 cm⁻¹ was subtracted with the absorbance value for the base line at 2475 cm⁻¹ (A_{methylacrylate}−A₂₄₇₅). Then the maximum absorbance peak for the polyethylene peak at 2660 cm⁻¹ was subtracted with the absorbance value for the base line at 2475 cm⁻¹ (A₂₆₆₀−A₂₄₇₅). The ratio between (A_{methylacrylate}−A₂₄₇₅) and (A₂₆₆₀−A₂₄₇₅) was then calculated in the conventional manner which is well documented in the literature.

The weight-% can be converted to mol-% by calculation. It is well documented in the literature.

### Quantification of Copolymer Content in Polymers by NMR Spectroscopy

The comonomer content was determined by quantitative nuclear magnetic resonance (NMR) spectroscopy after basic assignment (e.g. “NMR Spectra of Polymers and Polymer Additives”, A. J. Brandolini and D. D. Hills, 2000, Marcel Dekker, Inc. New York). Experimental parameters were adjusted to ensure measurement of quantitative spectra for this specific task (e.g “200 and More NMR Experiments: A Practical Course”, S. Berger and S. Braun, 2004, Wiley-VCH, Weinheim). Quantities were calculated using simple corrected ratios of the signal integrals of representative sites in a manner known in the art.

### (2) Polymers Containing 6 wt. % or Less Polar Comonomer Units

Comonomer content (wt. %) was determined in a known manner based on Fourier transform infrared spectroscopy (FTIR) determination calibrated with quantitative nuclear magnetic resonance (NMR) spectroscopy. Below is exemplified the determination of the polar comonomer content of ethylene butyl acrylate and ethylene methyl acrylate. For the FT-IR measurement a film samples of 0.05 to 0.12 mm thickness were prepared as described above under method 1). The accurate thickness of the obtained film samples was measured.

After the analysis with FT-IR base lines in absorbance mode were drawn for the peaks to be analysed. The maximum absorbance for the peak for the comonomer (e.g. for methylacrylate at 1164 cm⁻¹ and butylacrylate at 1165 cm⁻¹) was subtracted with the absorbance value for the base line at 1850 cm⁻¹ (A_{polar comonomer}−A₁₈₅₀). Then the maximum absorbance peak for polyethylene peak at 2660 cm⁻¹ was subtracted with the absorbance value for the base line at 1850 cm⁻¹ (A₂₆₆₀−A₁₈₅₀). The ratio between (A_{comonomer}−A₁₈₅₀) and (A₂₆₆₀−A₁₈₅₀) was then calculated. The NMR spectroscopy calibration procedure was undertaken in the conventional manner which is well documented in the literature, as described above under method 1).

The weight-% can be converted to mol-% by calculation. It is well documented in the literature.

Below is exemplified how polar comonomer content obtained from the above method (1) or (2), depending on the amount thereof, can be converted to micromol or mmol per g polar comonomer as used in the definitions in the text and claims:

The millimoles (mmol) and the micro mole calculations have been done as described below.

For example, if 1 g of the poly(ethylene-co-butylacrylate) polymer, which contains 20 wt % butylacrylate, then this material contains 0.20/M_{butylacrylate} (128 g/mol)=1.56×10⁻³ mol. (=1563 micromoles).

The content of polar comonomer units in the polar copolymer C_{polar comonomer} is expressed in mmol/g (copolymer). For example, a polar poly(ethylene-co-butylacrylate) polymer which contains 20 wt. % butyl acrylate comonomer units has a C_{polar comonomer} of 1.56 mmol/g.

The used molecular weights are: M_{butylacrylate}=128 g/mole, M_{ethylacrylate}=100 g/mole, M_{methylacrylate}=86 g/mole).

### Density

Low density polyethylene (LDPE): The density was measured according to ISO 1183-2. The sample preparation was executed according to ISO 1872-2 Table 3 Q (compression moulding).

Density of the PP polymer was measured according to ISO 1183/1872-2B.

### Method for Determination of the Amount of Double Bonds in the Polymer Composition or in the Polymer

This can be carried out following the protocol in WO2011/057928.

### Melting Temperature

Melting temperature (Tm), is measured with Mettler TA820 differential scanning calorimetry (DSC) on 5-10 mg samples. Melting curves are obtained during 10° C./min cooling and heating scans between 30° C. and 225° C. Melting temperatures were taken as the peaks of endotherms and exotherms.

### DC Conductivity Measurement (I):

The test cell consisted of a three electrode system setup (measuring area of Ø=60 mm), placed in an oven at 70° C. and connected to a high-voltage power supply (Glassman FJ60R2). A DC voltage of 9.9 kV was applied across 0.33 mm thick specimen films for 23 h and the voltage was switched-off for 1 h. The same voltage was subsequently re-applied for another 23 h. The DC conductivity was calculated based on the charging currents obtained at the end of each 23 h period. The volume leakage current was recorded with a Keithley 6517B electrometer, and dynamically averaged. In addition, a low pass filter was added into the circuit at the high voltage side for limiting the current in case of specimen breakdown and for filtering out high frequency noise.

### Materials

LDPE: LDPE homopolymer with a MFI˜2 g/10 min (190° C./2.16 kg) was obtained from Borealis AB (M_{w}˜117 kg mol⁻¹, PDI˜9, number of long-chain branches˜1.9).

iPP: Isotactic polypropylene with a MFI˜3.3 g/10 min (230° C./2.16 kg) was obtained from Borealis AB (M, ˜411 kg mol⁻¹, PDI˜8.5).

SEBS: Poly[styrene-b-(ethylene-co-butylene)-b-styrene] (SEBS) with MFI˜<1 g/10 min (230° C./2.16 kg) and 18.5-22.5% polystyrene content was obtained from Kraton Corporation (Kraton G1642 HU).

### EXPERIMENTAL

### Example 1 and 2 Sample Preparation Method

Copolymer formulations were compounded through extrusion for 5 minutes at 180° C. using an Xplore Micro Compounder MC5. The extruded material was heated to 200° C. and pressed up to a pressure of 3750 kPa for 1 minute in a hot press, resulting in 0.3 mm thick plates.

### Example 1

The following blends are first prepared:

TABLE 1

| | CE 1 | IE 1 | IE 2 | IE 3 |
|---|---|---|---|---|
| “LDPE” [weight %] | 100 | 75 | 90 | 95 |
| “iPP” [weight %] | | 25 | 10 | 5 |
| Temperature [° C.] | 70 | 70 | 70 | 70 |
| Electric field [kV | 30 | 30 | 30 | 30 |
| mm⁻¹] | | | | |
| DC conductivity | 34.3 | 6.79 | 4.23 | 22.1 |
| after 24 h [fS m⁻¹] | | | | |
| DC conductivity | 36.2 | 4.49 | 2.90 | 16.6 |
| after 48 h [fS m⁻¹] | | | | |

As can be seen in Table 1, LDPE (CE1) has a DC conductivity of about 35 fS/m. However, by gradually increasing iPP content (see IE1-IE3), significantly lower DC conductivity is reached (˜3-22 fS/m).

The cleanliness should be high since the blends (IE1-IE3) only contain super clean materials (LDPE and capacitor grade iPP).

Finally, since the blends are thermoplastic (and hence free of peroxides), they should not possess any of the above outlined drawbacks of peroxide XLPE.

### Example 2

The following blends are then prepared:

TABLE 2

| | CE2 | IE4 | IE5 | IE6 | IE7 |
|---|---|---|---|---|---|
| “LDPE” [wt %] | 95 | 76 | 57 | 38 | 19 |
| “iPP” [weight %] | | 19 | 38 | 57 | 76 |
| “SEBS” [wt %] | 5 | 5 | 5 | 5 | 5 |
| Temperature [° C.] | 70 | 70 | 70 | 70 | 70 |
| Electric field [kV | 30 | 30 | 30 | 30 | 30 |
| mm⁻¹] | | | | | |
| DC conductivity | 25.3 | 5.65 | 3.04 | 5.08 | 1.44 |
| after 24 h [fS m⁻¹] | | | | | |
| DC conductivity | 19.3 | 3.72 | 2.17 | 2.95 | 0.574 |
| after 48 h [fS m⁻¹] | | | | | |

As can be seen in Table 1/2, LDPE (CE1) & LDPE+5% SEBS (CE2) have DC conductivity of about 20-35 fS/m. However, by gradually increasing the amount of iPP (see IE4-IE7), significantly lower DC conductivity is reached (˜0.5-5 fS/m).

In principle, the cleanliness should be high since the blends (IE4-IE7) mainly contain super clean materials (LDPE and/or capacitor grade iPP).

Finally, since blends are thermoplastic (and hence free of peroxides), they should not possess any of the above outlined drawbacks of peroxide XLPE.

1. A cable comprising one or more conductors surrounded by at least one layer, wherein said layer comprises:
(i) 15 to 84.5 wt % low density polyethylene (LDPE);
(ii) a polypropylene; and
(iii) a styrene block copolymer;
wherein the weight percentages are based on the layer as a whole.

2. The cable as claimed in claim 1, wherein said layer comprises:
(i) 15 to 80 wt % LDPE;
(ii) 8.0 to 80 wt % of the polypropylene; and
(iii) 2.0 to 10 wt % of the styrene block copolymer;
wherein the weight percentages are based on the layer as a whole.

3. The cable as claimed in claim 1, wherein the polypropylene (ii) is a propylene homopolymer.

4. The cable as claimed in claim 1, wherein the LDPE is a LDPE homopolymer.

5. The cable as claimed in claim 1, wherein the LDPE has a density of 915 to 940 kg/m³.

6. The cable as claimed in claim 1, wherein the styrene block copolymer (iii) is selected from the group consisting of Poly[styrene-b-(ethylene-co-butylene)-b-styrene](SEBS), Poly[styrene-b-(ethylene-co-propylene)-b-styrene] (SEPS), Poly[styrene-b-(butadiene)-b-styrene] (SBS), and Poly[styrene-b-(isoprene)-b-styrene] (SIS).

7. cable as claimed in claim 1, wherein said layer does not comprise a peroxide or is not crosslinked.

8. The cable as claimed in claim 1, wherein the layer comprises:
(i) 15 to 84.0 wt % low density polyethylene (LDPE);
(ii) 15 to 84.0 wt % of the polypropylene; and
(iii) 1.0 to 15 wt % of the styrene block copolymer.

9. A cable comprising one or more conductors surrounded by at least one layer, wherein said layer consists essentially of:
(i) 60 to 95 wt % LDPE; and
(ii) 5 to 40 wt % of a polypropylene;
wherein the weight percentages are based on the layer as a whole.

10. The cable as claimed in claim 9, wherein said layer comprises
(i) 70 to 95 wt % LDPE; and
(ii) 5 to 30 wt % of the polypropylene
wherein the weight percentages are based on the layer as a whole.

11. The cable as claimed in claim 9, wherein said LDPE is a homopolymer and said polypropylene is a homopolymer.

12. The cable as claimed in claim 1, wherein said layer is an insulation layer.

13. The cable as claimed in claim 1, where said one or more conductors are surrounded by at least an inner semiconductive layer, an insulation layer, and an outer semiconductive layer, in that order.

14. The cable as claimed in claim 1, wherein the insulation layer of said cable is not crosslinked.

15. The cable as claimed in claim 1, wherein said layer has a DC conductivity of 0.5 to 25 fS/m when measured after 24 hrs at 30 kV/mm and a temperature of 70° C.

16. A process for producing the cable of claim 1, the process comprising the steps of: applying the at least one layer on the one or more conductors.

17. The cable of claim 1, wherein the cable is a power cable.

18. The cable as claimed in claim 1, wherein the layer comprises:
(i) 15 to 80 wt % LDPE, wherein the LDPE is a LDPE homopolymer;
(ii) 15 to 80 wt % of the polypropylene, wherein the polypropylene is a propylene homopolymer; and
(iii) 2.0 to 10 wt % of the styrene block copolymer.

19. The cable as claimed in claim 1, wherein the layer comprises:
(i) 15 to 50 wt % LDPE, wherein the LDPE is a LDPE homopolymer;
(ii) 40 to 80 wt % of the polypropylene, wherein the polypropylene is a propylene homopolymer; and
(iii) 3.0 to 8.0 wt % of the styrene block copolymer.

20. The cable as claimed in claim 1, wherein the polypropylene (ii) is an isotactic polypropylene homopolymer.
